(19) United States
(12) Patent Application Publication
(10) Pub. No.: US 2010/0109790 A1
(43) Pub. Date: May 6, 2010

(54) Multilayer Complementary-conducting-strip Transmission Line Structure

(75) Inventors: Ching-Kuang Tzuang, Taipei City (TW); Meng-Ju Chiang, Taipei City (TW); Shian-Shun Wu, Taipei City (TW)

Correspondence Address: WPAT, PC;INTELLECTUAL PROPERTY ATTORNEYS, 7225 BEVERLY ST., ANNANDALE, VA, 22003, US

(73) Assignees: NATIONAL TAIWAN UNIVERSITY, Taipei City (TW); CMSC, INC., Hsinchu (TW)

(21) Appl. No.: 12/507,973

(22) Filed: Jul. 23, 2009

(30) Foreign Application Priority Data
Nov. 4, 2008 (TW) 097142455

(51) Int. Cl. H01P 3/08

(52) U.S. Cl. 333/1; 333/238

(57) ABSTRACT

A multilayer complementary-conducting-strip transmission line (CCS TL) structure is disclosed herein. The multilayer CCS TL structure includes a substrate, and n signal transmission lines being parallel and interlacing with n-1 mesh ground plane(s), therein a plurality of inter-media-dielectric (IMD) layers are correspondingly stacked with among the n signal transmission lines and the n-1 mesh ground plane(s) to form a stack structure on the substrate, therein n≧2 and n is a natural number. Whereby, a multilayer CCS TL with independent of each layer and complete effect on signal shield is formed to provide more flexible for circuit design, reduce the circuit area and also diminish the transmission loss.

### BACKGROUND OF THE INVENTION

1. Field of the Invention

This invention generally relates to the field of signal transmission line structure, and more particularly, to a multilayer complementary-conducting-strip transmission line (thereinafter called CCS TL) structure.

2. Description of the Prior Art

The successfully transmission-line-based (TL-based) hybrid designs for system-on-chip (SOC) integration are relied on highly efficient miniaturization. Numerous design techniques and circuit implementations had been reported and demonstrated for the desired circuit requirements. By either using capacitive loading (M. C. Scardelletti, G. E. Ponchak, and T. M. Weller, “Miniaturized Wilkinson power dividers utilizing capacitive loading,” IEEE Microwave Wireless Compon. Lett., vol. 12, no. 1, pp. 6-8, Jan. 2002.) or inductive loading (K. Hettak, G. A. Morin, and M. G. Stubbs, “Compact MMIC CPW and asymmetric CPS branch-line coupler and Wilkinson dividers using shunt and series stub loading,” IEEE Trans. Microwave Theory and Tech., vol. 53, no. 5, pp. 1624-1635, May 2005.), the reduction of physical transmission line length in hybrid, coupler, and power divider designs cab be achieved at least 60%.

On the other hand, the well-published technique, so-called the 3-D MMIC technology (K. Nishikawa, T. Tokumitsu, and I. Toyoda, “Miniaturized Wilkinson power divider using three-dimensional MMIC technology,” IEEE Microwave Guided Wave Lett., vol. 6, no. 10, pp. 372-374, October 1996.; C. Y. Ng, M. Chongcheawchamnan, I. D. Robertson, “Lumped-distributed hybrids in 3D-MMIC technology,” IEEE Proc.—Microwave. Antennas and Propag., vol. 151, no. 4, pp. 370-374, August 2004.; I. Toyoda, T. Tokumitsu, and M. Ailawa, “Highly integrated three-dimensional MMIC single-chip receiver and transmitter,” IEEE Trans. Microwave Theory Tech., vol. 44, no. 12, pp. 2340-2346, December 1996.), is demonstrated the fundamental breakthrough on multilayer transmission line implementations using GaAs technology. In the 3-D MMIC designs, the upper line and lower line are shielded by the intermedia metal with the slit. The size of slit can be applied to control the coupling and characteristic impedances of two transmission lines. Such implementation had been widely applied to the 3-D miniaturized designs of power divider (K. Nishikawa, T. Tokumitsu, and I. Toyoda, “Miniaturized Wilkinson power divider using three-dimensional MMIC technology,” IEEE Microwave Guided Wave Lett., vol. 6, no. 10, pp. 372-374, October 1996.), hybrid (C. Y. Ng, M. Chongcheawchamnan, I. D. Robertson, “Lumped-distributed hybrids in 3D-MMIC technology,” IEEE Proc.—Microwave. Antennas and Propag., vol. 151, no. 4, pp. 370-374, August 2004.), and high-density integrated transceiver (I. Toyoda, T. Tokumitsu, and M. Ailawa, “Highly integrated three-dimensional MMIC single-chip receiver and transmitter,” IEEE Trans. Microwave Theory Tech., vol. 44, no. 12, pp. 2340-2346, December 1996.).

Recently, the multilayer design technique is applied to microwave/millimeter-wave CMOS distributed passive components (M. Chirala, and C. Nguyen, “Multilayer Design Techniques for Extremely Miniaturized CMOS Microwave and Millimeter-Wave Distributed Passive Circuit,” IEEE Trans. Microwave Theory Tech., vol. 54, no. 12, pp. 4218-4224, December 2006.). The microwave/millimeter-wave rat-race hybrid is designed by incorporating the multilayer microstrip lines. The reference ground plane is realized by the uniform bottom metal in CMOS processes. The signal traces can be arranged in the meandered-form and no extra shielding metal is inserted between upper and lower microstrip lines. Hence, between upper and lower microstrip lines, there has no any effective signal shield.

In view of the drawbacks mentioned with the prior art of signal transmission line, there is a continuous need to develop a new and improved multilayer CCS TL structure that overcomes the shortages associated with the prior art. The advantages of the present invention are that it solves the problems mentioned above.

### SUMMARY OF THE INVENTION

In accordance with the present invention, a CCS TL structure substantially obviates one or more of the problems resulted from the limitations and disadvantages of the prior art mentioned in the background.

One of the purposes of the present invention is to change the characteristic impedance of a CCS TL by varying the slot size of the mesh ground plane in order to increase the flexibility and variety for circuit designs.

One of the purposes of the present invention is to isolate the CCS TL by mesh ground plane(s) in order to provide a complete signal shield and grounding.

One of the purposes of the present invention is to form a multilayer CCS TL with the character of independent and complete shielding for each layer by integrating the structures of multilayer CMOS and mesh ground planes in order to provide much flexibility for circuit designs, miniaturization, and less loss in signal transmission.

The present invention provides a multilayer CCS TL structure. The multilayer CCS TL structure includes a substrate, and n signal transmission lines being parallel and interlacing with n-1 mesh ground plane(s), herein a plurality of inter-media-dielectric (thereinafter called IMD) layers are correspondingly stacked with among the n signal transmission lines and the n-1 mesh ground plane(s) to form a stack structure on the substrate, herein n is a natural number and n≧2.

The present invention offers a multilayer CCS TL structure. The multilayer CCS TL structure includes a first signal transmission line, a second signal transmission line being parallel with the first signal transmission line, a mesh ground plane being between the first and the second signal transmission lines, herein two IMD layers are sandwiched correspondingly among the mesh ground plane, the first and the second signal transmission lines to form a stack structure, and a substrate being beneath the stack structure.

The present invention provides a multilayer CCS TL structure. The multilayer CCS TL structure includes a substrate, a signal transmission line being above the substrate, and a mesh ground plane being between the substrate and the signal transmission line, herein two IMD layers are sandwiched respectively among the substrate, the mesh ground plane, and the transmission line.

The present invention offers a multilayer CCS TL structure. The multilayer CCS TL structure includes a substrate, a signal transmission line being on the substrate, and a mesh ground plane being above the signal transmission line, herein two IMD layers are sandwiched respectively between the mesh ground plane and the signal transmission line and on the mesh ground plane.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 illustrates the three-dimensional perspective structure of one preferred embodiment in accordance with the present invention;

FIG. 2 illustrates the cross-sectional structure of one preferred signal transmission line embodiment in accordance with the present invention;

FIG. 3A shows the layout of one preferred application circuit combined by several preferred embodiments in accordance with the present invention;

FIG. 3B illustrates the three-dimensional perspective structure of another preferred embodiment in accordance with the present invention;

FIG. 3C illustrates the three-dimensional perspective structure of further another preferred embodiment in accordance with the present invention;

FIG. 4A shows the relation curves between the complex characteristic impedance (Z_{c}) and frequency which are extracted from one preferred embodiment in accordance with the present invention; and

FIG. 4B shows the relation curves among the slow-wave factor (SWF), quality-factor (Q), and frequency which are extracted from one preferred embodiment in accordance with the present invention.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

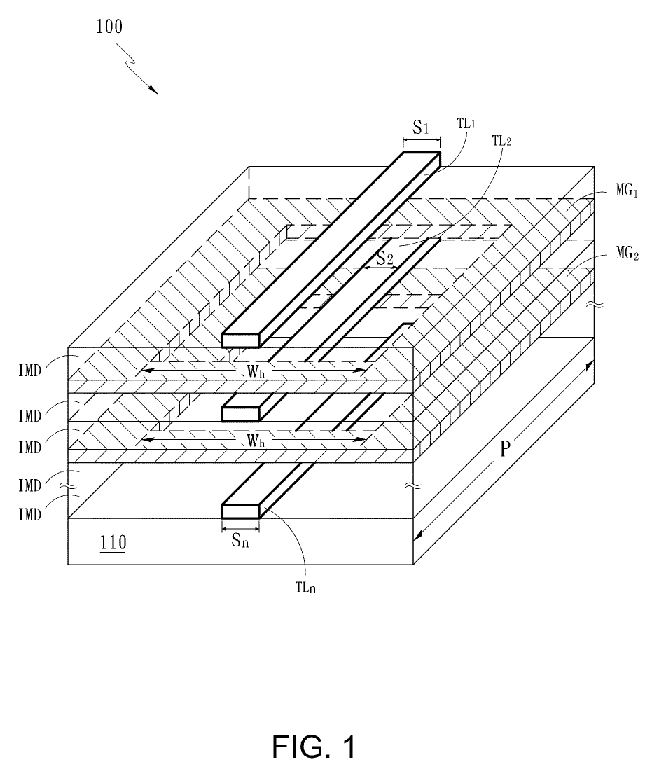

Referring to FIG. 1, the three-dimensional perspective structure of one preferred embodiment 100 in accordance with the present invention is illustrated. A substrate 110 has the size of one periodicity P. n signal transmission lines TL₁, TL₂, . . . , and TLₙ are parallel and interlace with n-1 mesh ground planes MG₁, MG₂, . . . , and MGₙ₋₁ (not shown), that is, the mesh ground planes MG₁ is between the signal transmission lines TL₁ and TL₂, the mesh ground planes MG₂ is between the signal transmission lines TL₂ and TL₃ (not shown), . . . , and the mesh ground plane MGₙ₋₁ is between the signal transmission lines TLₙ₋₁ (not shown) and TLₙ. Herein, a plurality of inter-media-dielectric (thereinafter called IMD) layers IMD are correspondingly stacked with among the n signal transmission lines TL₁, TL₂, . . . , and TLₙ and the n-1 mesh ground planes MG₁, MG₂, . . . , and MGₙ₋₁ (for example, an IMD layer IMD is between the signal transmission line TL₁ and the mesh ground plane MG₁, another IMD layer IMD is between the mesh ground plane MG₁ and the signal transmission line TL₂, . . . , and still another IMD layer IMD is between the mesh ground plane MGₙ₋₁ and the signal transmission line TLₙ) to form a stack structure on the substrate 110, wherein n is a natural number and n≧2. The n signal transmission lines TL₁, TL₂, . . . , and TLₙ include straight-line form and the widths thereof refer to S₁, S₂, . . . , and Sₙ, respectively.

In the present embodiment, each mesh ground plane, such as MG₁, MG₂, . . . , and MGₙ₋₁, is a metal layer with an inner slot, and the size of the inner slot is defined by mesh slot Wₕ. In the present embodiment, the n signal transmission lines TL₁, TL₂, . . . , and TLₙ are independent and have complete effect on signal shield in order to provide much flexibility for circuit designs, miniaturization, and less loss in signal transmission. Besides, the word “parallel” in the present embodiment is the concept of planes being parallel in space, and hence the n signal transmission lines TL₁, TL₂, . . . , and TLₙ are not limited to the same direction. That is, they also could be parallel but have any degree in direction, such as 90 degree. The inventor would like to emphasize that the geometric shape for the substrate 110, the mesh ground planes MG₁, MG₂, . . . , and MGₙ₋₁, and the IMD layer IMD can be variety, and should not be limited to the square shape shown in the present embodiment.

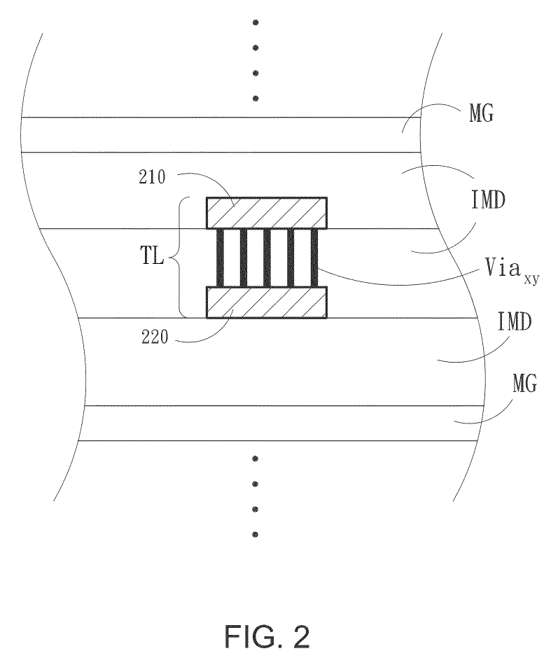

Referring to FIG. 2, the cross-sectional structure of one preferred signal transmission line embodiment in accordance with the present invention is illustrated. A signal transmission line TL includes two sub-signal-transmission-lines 210, 220 and a plurality of first vias Via_{xy}. Herein, x, y represent natural numbers and y=x+1. The two sub-signal-transmission-lines 210, 220 are two different layers of metal transmission lines in a CMOS structure. They are connected by the plurality of first vias Via_{xy} to form the signal transmission line TL in order to increase the thickness of the signal transmission line in the CMOS structure. MG and IMD denote the mesh ground planes and the IMD layers, respectively. The present embodiment can be applied to the signal transmission lines TL₂, . . . , and TLₙ shown in FIG. 1 to change the character of the transmission lines.

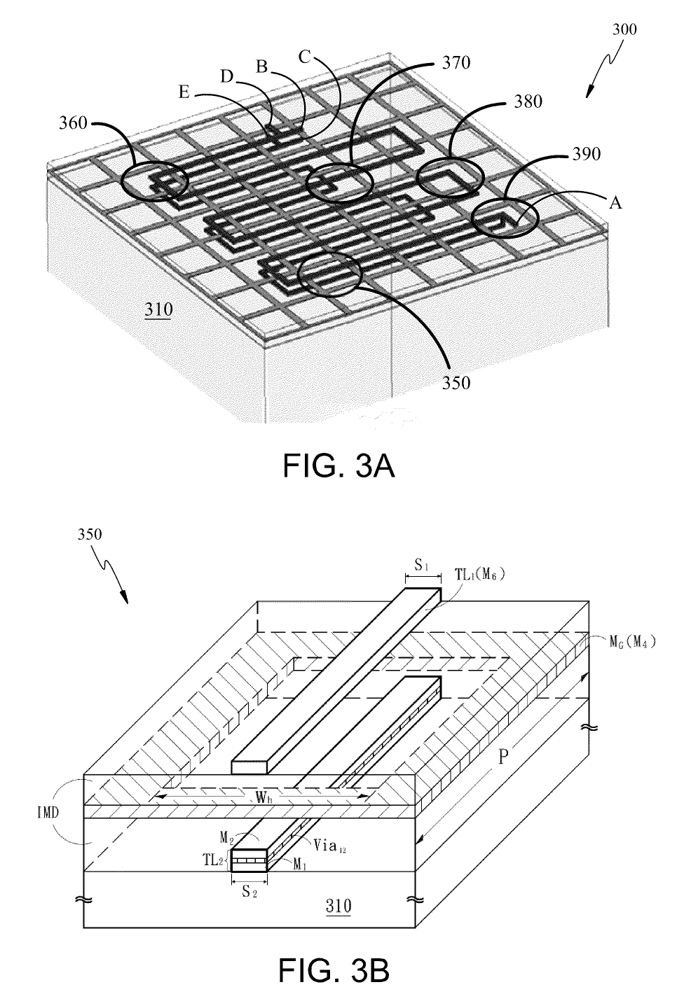

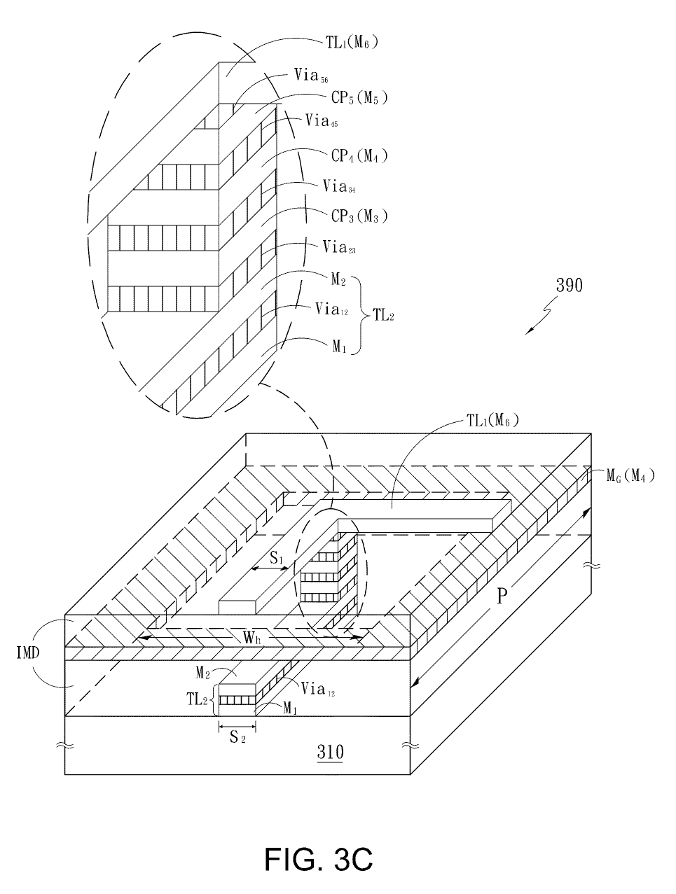

Referring to FIG. 3A, the layout for one preferred application circuit 300 integrated by several preferred embodiments in accordance with the present invention is illustrated. The application circuit 300 is a Ka-band power divider designed by multilayer CCS TL structures 350, 360, 370, 380, and 390. Herein, a plurality of ends A, B, and C refer to the ports 1, 2, and 3 of the application circuit 300, respectively, and a connecting resistor (not shown) connects two ends D and E. Or, the ends A, D, and E are the ports 1, 2, and 3 of the application circuit 300, correspondingly, and the connecting resistor connects the ends B and C. The structure of the embodiment 350 will be described as below firstly. The embodiment 350, referring to FIG. 3B, shows the structure of the embodiment 100 depicted in FIG. 1 in case of n=2. A first signal transmission line TL₁ (M₆) with the size S₁ in width. A second signal transmission line TL₂ having the size S₂ in width and is parallel with the first signal transmission line TL₁ (M₆). A mesh ground plane MG (M₄) is between the first and the second signal transmission lines TL₁ (M₆) and TL₂. Herein, two IMD layers IMD are respectively among the mesh ground plane MG (M₄) and the first and the second signal transmission lines TL₁ (M₆) and TL₂ to form a stack structure. A substrate 310 has the size P in periodicity and is beneath the stack structure.

Herein, the second signal transmission line TL₂ includes two sub-signal-transmission-lines M₁, M₂ and a plurality of first vias Via_{xy}, such as Via₁₂ (similar to the transmission line structure described in FIG. 2). In a CMOS structure, the two sub-signal-transmission-lines M₁, M₂ in the present embodiment are the metal transmission lines on the first layer and on the second layer, respectively. They are connected by the plurality of first vias Via₁₂ to form the signal transmission line TL₂ in order to increase the thickness of the signal transmission line in the CMOS structure. In the present embodiment, the mesh ground plane MG (M₄) is the fourth metal layer and the size of the inner slot thereof is defined by mesh slot Wₕ. The first signal transmission line TL₁ (M₆) in the present embodiment locates on the sixth metal layer. Accordingly, the embodiment 350 is implemented in the 1P6M CMOS structure.

Referring to FIG. 3A again, the embodiments 360 and 370 are similar to the embodiment 350. The differences among them are that the first and the second transmission lines TL₁ and TL₂ are straight lines in the embodiment 350, the first and the second transmission lines TL₁ and TL₂ show L-line form in the embodiment 360, and the first and the second transmission lines TL₁ and TL₂ show straight and L-shape, respectively, in the embodiment 370. Likewise, the signal transmission lines TL₁ and TL₂ could respectively be L-shape and straight. Moreover, referring to the ends B, C, D, and E, the signal transmission lines TL₁ and TL₂ also could be T-shape.

Referring to FIG. 3A again, the embodiments 380 and 390 are similar to the embodiment 350. The differences between the embodiments 350 and 380 are that the embodiment 350 has the first and the second transmission lines TL₁ and TL₂ being straight, but the embodiment 380 only has the first transmission line TL₁ being L-shape (also could be straight or T-shape). The structure of the embodiment 380 will be described as below (taking the embodiment 350 for explanation). A substrate 310 has the size P in periodicity. A signal transmission line TL₁ is above the substrate 310. A mesh ground plane MG is between the substrate 310 and the signal transmission lines TL₁. Herein, two IMD layers IMD are among the mesh ground plane MG and the substrate 310 and the signal transmission lines TL₁, respectively. Also, the present invention can be implemented by the structure described as below (still taking the embodiment 350 for explanation). A substrate 310 has the size P in periodicity. A signal transmission line TL₂ is on the substrate 310. A mesh ground plane MG is above the signal transmission lines TL₂. Herein, two IMD layers IMD are respectively between the mesh ground plane MG and the signal transmission lines TL₂ and on the mesh ground plane MG. That is, the present embodiment only has the second signal transmission line TL₂ (could be straight, L-shape, or T-shape) of the embodiment 350 and its structure is the same as the second signal transmission line TL₂ shown in the embodiment 350, and hence this part will not be repeated here. The big difference between the embodiments 350 and 390 (referring to FIG. 3C) is that the embodiment 390 further includes a second via connecting the first and the second transmission lines TL₁ and TL₂. Herein, the second via includes a plurality of sub-vias and at least one metal layer structure. In the present embodiment, the second via at least has metal layers CP₃, CP₄, CP₅, and a plurality of sub-vias Via₂₃, Via₃₄, Via₄₅, and Via₅₆ to connect the first and the second transmission lines TL₁ and TL₂. Besides, the features of the first signal transmission line TL₁ being L-shape (also could be straight or T-shape) and the second signal transmission line TL₂ connecting the first signal transmission line TL₁ through the second via in the embodiment 390 are also distinguished from the embodiment 350. The features of the embodiments described above can be applied to all embodiments in accordance with the present invention and should not be used to limit the implementing thereof.

The inventor would like to emphasize that the n signal transmission lines (or as n=2, the first and the second transmission lines) can be designed for multilayer (or two-layer) independent circuits. Since the mesh ground planes provides complete grounding effect, the interference resulting from the signals on different layers can be decreased to lower the loss in signal transmission and provide much flexibility and miniaturization for circuit designs.

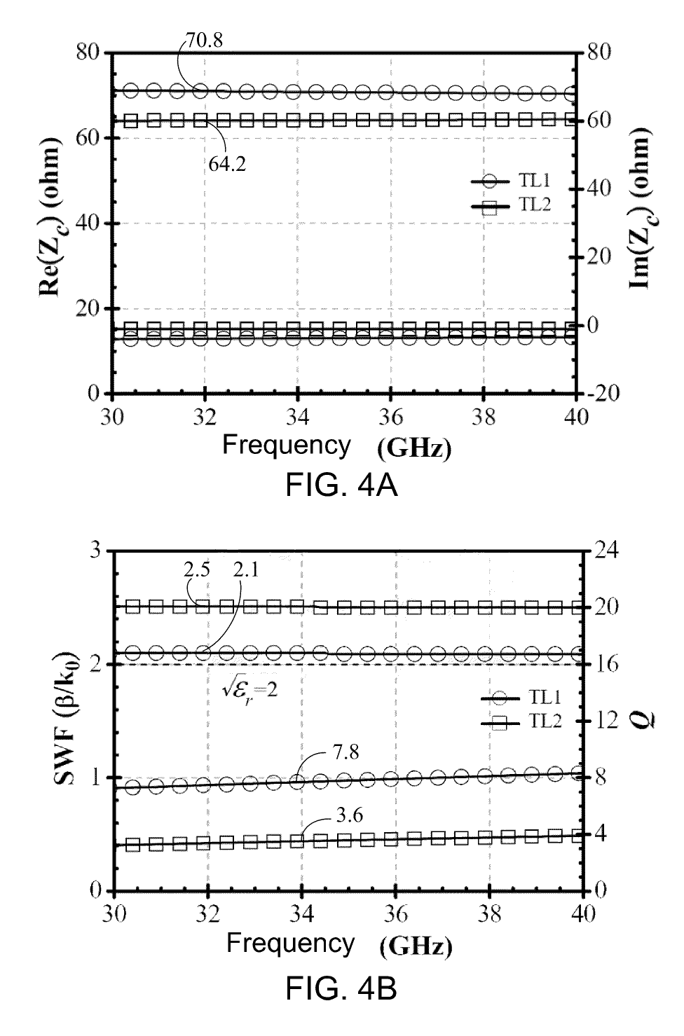

Referring to FIGS. 4A and 4B, the relation curves among the complex characteristic impedance (Z_{c}) of the first and the second transmission lines and frequency which are extracted from the embodiment 350 in case of n=2, and the relation curves among the slow-wave factor (SWF) and quality-factor (Q) of the first and the second transmission lines and frequency are shown, respectively. The inventor would like to stress here that the related data set for simulations and the results obtained from simulations are only used to explain the simulation processes and the results of preferred embodiments in accordance with the present invention, but not limit the implementing of the present invention.

The data set for simulations is defined as below. The widths S₁ and S₂ of the transmission lines TL₁ and TL₂ are respectively 3.0 μm and 2.0 μm, and the thicknesses of the TL₁ (M₆) and TL₂ (MlM₂) are 2.0 μm and 1.95 μm, respectively. The thicknesses of IMD layers IMDs from the metal layers M₂ to M₄ and M₄ to M₆ are 2.25 μm, respectively. The relative dielectric constant of the IMD is 4.0. The periodicity P is defined as 30.0 μm. The mesh slot size Wₕ is 26.0 μm. Moreover, the simulations are performed by the commercial software package Ansoft HFSS, and the results obtained from the simulations are shown in FIGS. 4A and 4B, respectively.

In FIG. 4A, the real parts of Z_{c} of the first and the second transmission lines TL₁ and TL₂ at Ka-band are 70.8Ω and 64.2Ω, respectively. The imaginary parts of Z_{c} are nearly identical. In FIG. 4B, the SWFs of the first and the second transmission lines TL₁ and TL₂ at Ka-band are 2.10 and 2.51, respectively, and the quality-factors of the first and the second transmission lines TL₁ and TL₂ at Ka-band are respectively 7.8 and 3.6.

Although specific embodiments have been illustrated and described, it will be obvious to those skilled in the art that various modifications may be made without departing from what is intended to be limited solely by the appended claims.

What is claimed is:

1. A multilayer complementary-conducting-strip transmission line structure, comprising:
a substrate; and
n signal transmission lines, being parallel and interlacing with n-1 mesh ground plane(s), wherein a plurality of inter-media-dielectric layers are correspondingly stacked with among said n signal transmission lines and said n-1 mesh ground plane(s) to form a stack structure on said substrate, wherein n is a natural number and n≧2.

2. The multilayer complementary-conducting-strip transmission line structure according to claim 1, wherein said n signal transmission lines individually comprise two sub-signal-transmission-lines and a plurality of first vias, said two sub-signal-transmission-lines are on different metal layer of a complementary metal-oxide semiconductor structure.

3. The multilayer complementary-conducting-strip transmission line structure according to claim 1, wherein said n signal transmission lines comprise straight-line form.

4. The multilayer complementary-conducting-strip transmission line structure according to claim 1, wherein said n signal transmission lines comprise L-line form.

5. The multilayer complementary-conducting-strip transmission line structure according to claim 1, wherein said n signal transmission lines comprise T-line form.

6. The multilayer complementary-conducting-strip transmission line structure according to claim 1, further comprising a second via connecting said n signal transmission lines.

7. A multilayer complementary-conducting-strip transmission line structure, comprising:
a first signal transmission line;
a second signal transmission line, being parallel with said first signal transmission line;
a mesh ground plane, being between said first and said second signal transmission lines, wherein two inter-media-dielectric layers are sandwiched correspondingly among said mesh ground plane, said first and said second signal transmission lines to form a stack structure; and
a substrate, being beneath said stack structure.

8. The multilayer complementary-conducting-strip transmission line structure according to claim 7, wherein said first signal transmission line comprises straight-line form.

9. The multilayer complementary-conducting-strip transmission line structure according to claim 7, wherein said first signal transmission line comprises L-line form.

10. The multilayer complementary-conducting-strip transmission line structure according to claim 7, wherein said first signal transmission line comprises T-line form.

11. The multilayer complementary-conducting-strip transmission line structure according to claim 7, wherein said second signal transmission line comprises two sub-signal-transmission-lines and a plurality of first vias, said two sub-signal-transmission-lines are on different metal layer of a complementary metal-oxide semiconductor structure.

12. The multilayer complementary-conducting-strip transmission line structure according to claim 7, wherein said second signal transmission line comprises straight-line form.

13. The multilayer complementary-conducting-strip transmission line structure according to claim 7, wherein said second signal transmission line comprises L-line form.

14. The multilayer complementary-conducting-strip transmission line structure according to claim 7, wherein said second signal transmission line comprises T-line form.

15. The multilayer complementary-conducting-strip transmission line structure according to claim 7, further comprising a second via connecting said first and said second signal transmission lines.

16. A multilayer complementary-conducting-strip transmission line structure, comprising:
a substrate;
a signal transmission line, being above said substrate; and
a mesh ground plane, being between said substrate and said signal transmission line, wherein two inter-media-dielectric layers are sandwiched respectively among said substrate, said mesh ground plane, and said transmission line.

17. The multilayer complementary-conducting-strip transmission line structure according to claim 16, wherein said signal transmission line comprises straight-line form.

18. The multilayer complementary-conducting-strip transmission line structure according to claim 16, wherein said signal transmission line comprises L-line form.

19. The multilayer complementary-conducting-strip transmission line structure according to claim 16, wherein said signal transmission line comprises T-line form.

20. A multilayer complementary-conducting-strip transmission line structure, comprising:
a substrate;
a signal transmission line, being on said substrate; and
a mesh ground plane, being above said signal transmission line, wherein two inter-media-dielectric layers are respectively sandwiched between said mesh ground plane and said signal transmission line and on said mesh ground plane.

21. The multilayer complementary-conducting-strip transmission line structure according to claim 20, wherein said signal transmission line comprises two sub-signal-transmission-lines and a plurality of first vias, said two sub-signal-transmission-lines are on different metal layer of a complementary metal-oxide semiconductor structure.

22. The multilayer complementary-conducting-strip transmission line structure according to claim 20, wherein said signal transmission line comprises straight-line form.

23. The multilayer complementary-conducting-strip transmission line structure according to claim 20, wherein said signal transmission line comprises L-line form.

24. The multilayer complementary-conducting-strip transmission line structure according to claim 20, wherein said signal transmission line comprises T-line form.
